(19) United States
(12) Patent Application Publication
(10) Pub. No.: US 2009/0175771 A1
(43) Pub. Date: Jul. 9, 2009

(54) ABATEMENT OF EFFLUENT GAS

(75) Inventors: Kenneth Chien-Quen Tsai, Emerald Hills, CA (US); Peter I. Porshnev, San Jose, CA (US); Mark W. Curry, Morgan Hill, CA (US); Sebastien Raoux, Santa Clara, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/348,012

(22) Filed: Jan. 1, 2009

Related U.S. Application Data
(63) Continuation-in-part of application No. 11/686,005, filed on Mar. 14, 2007.
(60) Provisional application No. 60/783,370, filed on Mar. 16, 2006.
(60) Provisional application No. 60/890,609, filed on Feb. 19, 2007.
(60) Provisional application No. 60/783,374, filed on Mar. 16, 2006.
(60) Provisional application No. 60/783,337, filed on Mar. 16, 2006.

(51) Int. Cl. B01D 53/74; G05B 1/00

(52) U.S. Cl. 423/210; 422/105

(57) ABSTRACT

Systems and methods are provided involving abatement of effluents. Aspects of the invention may include starting an abatement system at a high level setting; receiving an effluent having an undesirable material at the abatement system; abating the undesirable material using the abatement system at the high level setting; receiving information about the effluent; analyzing the information to determine an optimal setting; adjusting the high level setting to the optimal setting; and receiving more of the effluent having more of the undesirable material, which then may be attenuated. The optimal setting corresponds to a selected setting efficiency. Numerous other aspects are provided.

### CROSS-REFERENCE TO RELATED APPLICATIONS

The present application claims priority to and is a continuation-in-part application of:

U.S. patent application Ser. No. 11/686,005, filed Mar. 14, 2007, and titled “METHOD AND APPARATUS FOR IMPROVED OPERATION OF AN ABATEMENT SYSTEM” (Attorney Docket No. 9139), which claims priority to the following applications:

U.S. Provisional Patent Application No. 60/783,370, filed Mar. 16, 2006 and titled “METHODS AND APPARATUS FOR IMPROVING OPERATION OF AN ELECTRONIC DEVICE MANUFACTURING SYSTEM”, (Attorney Docket No. 9137/l);

U.S. Provisional Patent Application No. 60/890,609, filed Feb. 19, 2007 and titled “METHODS AND APPARATUS FOR A HYBRID LIFE CYCLE INVENTORY FOR ELECTRONIC DEVICE MANUFACTURING”, (Attorney Docket No. 9137/L2);

U.S. Provisional Patent Application No. 60/783,374, filed Mar. 16, 2006 and entitled “METHODS AND APPARATUS FOR PRESSURE CONTROL IN ELECTRONIC DEVICE MANUFACTURING SYSTEMS”, (Attorney Docket No. 9138/L); and incorporated herein by reference in its entirety for all purposes.

The present application is related to the following commonly-assigned, co-pending U.S. Patent Applications, each of which is hereby incorporated herein by reference in its entirety for all purposes:

U.S. patent application No. 11/685,993, filed Mar. 14, 2007, and titled “METHODS AND APPARATUS FOR IMPROVING OPERATION OF AN ELECTRONIC DEVICE MANUFACTURING SYSTEM” (Attorney Docket No. 9137/AGS/IBSS); and

U.S. patent application Ser. No. 11/686,012, filed Mar. 14, 2007, and titled “IMPROVED METHODS AND APPARATUS FOR PRESSURE CONTROL IN ELECTRONIC DEVICE MANUFACTURING SYSTEMS” (Attorney Docket No. 9138/AGS/IBSS).

### BACKGROUND OF THE INVENTION

1. Field of the Invention

Aspects of the present invention relate generally to systems and methods for manufacturing microelectronic structures, e.g., electronic device manufacturing systems, and more specifically to methods and apparatus for improved operation of an abatement system.

2. Description of Related Art

Electronic device manufacturing tools conventionally employ chambers or other suitable apparatus adapted to perform processes (e.g., chemical vapor deposition, epitaxial silicon growth, etch, etc.) to manufacture electronic devices. Such processes may produce effluents having undesirable chemicals as by-products of the processes. Conventional electronic and microelectronic structure and device manufacturing systems may use abatement apparatus to treat the effluents.

Conventional abatement units and processes employ a variety of resources (e.g., reagents, water, electricity, etc.) to treat the effluents. Such abatement units conventionally have been operated without regard to specific effluent compositions and with little information about the effluents being treated by the abatement units. Moreover, gas flow and composition information may be stored in confidential electronic structure processing recipes used to manufacture the structures, and these confidential recipes may not be available to an abatement unit.

Accordingly, conventional abatement units may use abatement resources sub-optimally. For instance, sub-optimal use of abatement resources may include excessive power consumption in generating plasma. Sub-optimal use of the resources may result in inefficient use of resources that incurs higher operating costs and an undesirable burden in a production facility. In addition, more frequent maintenance may be required for abatement units that do not use resources optimally.

Accordingly, a need exists for improved methods and apparatus for abating effluents.

### BRIEF SUMMARY OF THE INVENTION

Aspects of the present invention may include commencing abatement at high level settings at a start of a recipe lot, recording gas flows during processing of a first substrate of the lot, analyzing recipe gases used in the processing of the lot, determining optimal abatement settings for abatement of the effluent gases, implementing optimal abatement settings for abatement of the effluent gases of the recipe lot. Repetition of these actions may occur upon commencement of a new recipe lot having a new recipe.

In an embodiment of the invention, a method is provided comprising starting an abatement system at a high level setting; receiving an effluent having an undesirable material at the abatement system; abating the undesirable material using the abatement system at the high level setting; receiving information about the effluent; analyzing the information to determine an optimal setting, wherein the optimal setting corresponds to a selected setting efficiency; adjusting the high level setting to the optimal setting; and receiving more of the effluent having more of the undesirable material. More of the undesirable material may be attenuated at the optimal setting.

Other embodiments of the present invention may include a system including at least one sensor, an interface, and an abatement system. The at least one sensor may be adapted to measure gas information about gas present in an electronic device manufacturing system, and to communicate the gas information. The interface may be adapted to receive and analyze the gas information from the electronic device manufacturing system that produces an effluent having an undesirable material, to determine an optimal setting, and to communicate the optimal setting. The optimal setting may correspond to a selected setting efficiency. The abatement system may be adapted to receive the optimal setting, to receive the effluent, and to attenuate the undesirable material. The abatement system may be further adapted to commence abatement of the undesirable material of the effluent of a recipe lot while operating at a high level setting, and to adjust the high level setting to the optimal setting upon receiving the optimal setting.

Other features and aspects of the present invention will become more fully apparent from the following detailed description, the appended claims and the accompanying drawings.

### BRIEF DESCRIPTION OF THE DRAWINGS

By reference to the appended drawings, which illustrate exemplary embodiments of the invention, the detailed description provided below explains in detail various features, advantages and improvements of the present invention.

It is to be noted, however, that the appended drawings are not intended to necessarily be to scale or mechanically complete. They illustrate only isolated embodiments of this invention; they therefore are not to be considered as limiting of its scope, for the invention may admit to other equally effective embodiments.

FIG. 1 is a schematic drawing depicting an electronic device manufacturing system having an electronic device manufacturing tool, a pump, an interface, and an abatement system in accordance with the present invention.

FIG. 2 is a flowchart depicting a method of adjusting an abatement system in accordance with an embodiment of the present invention.

FIG. 3 is a curve illustrating an exemplary first relationship between destruction efficiency and plasma power used by a plasma abatement system employing the exemplary abatement process in accordance with the present invention.

FIG. 4 is a curve illustrating an exemplary second relationship between destruction efficiency and a flow of water as a reactant in a plasma abatement system employing the exemplary abatement process in accordance with the present invention.

### DETAILED DESCRIPTION

The present invention relates to methods and apparatus for optimizing the abatement of undesirable material produced during electronic device manufacturing. More specifically, the present invention relates to optimizing abatement systems that are adapted to attenuate or eliminate undesirable material in an effluent of an electronic device manufacturing tool.

An optimized abatement system may attenuate or eliminate undesirable material during an abatement process. The abatement process may use different types and/or amounts of resources for different undesirable materials in the effluent. By employing an optimized amount and/or type of the resources for the undesirable material, the optimized abatement system may minimize use of the resources, including time spent performing maintenance.

Abatement resources may be optimized through knowledge of the amount and/or type of materials to be abated. The materials to be abated will correlate to details of a recipe used to process a lot of substrates, referred to herein as a recipe lot. Changing from a first recipe to a second, new recipe likewise may change the materials to be abated during processing of a second, new recipe lot. Accordingly, in at least one embodiment of the invention, the amount and/or type of material to be abated from an effluent is determined during the abatement process (e.g., in situ and/or in real time) and/or based on information previously obtained from a reference system as will be described below.

Advantages of aspects of the present invention may include conservation of resources and/or reduced maintenance. For example, by using only the amount of power required to attenuate undesirable material, less power may be employed than would conventionally be used, thereby reducing an operating cost of the abatement system. Other examples may include extending the time between periodic maintenance of the abatement system, higher destruction efficiency of the undesirable material, etc.

The type and amount of undesirable material in the effluent may vary according to the processes performed, and recipes employed, by the electronic device manufacturing tool. The undesirable material in the effluent may be measured, predicted, etc. Gas information may be measured, such as by sensors, or provided by a recipe management tool, and the gas information may include details of recipe gases or effluent gases. Such information may be provided to an interface or another suitable apparatus that is adapted to analyze the information. The interface may provide the results of the analysis to the abatement system; and the abatement system may employ the results to optimally use or otherwise improve use of its abatement resources.

Abatement processes may abate effluents using water, RF power, temperature, natural gas, etc. A destruction efficiency of the abatement process may be related to the amount of resources used. The destruction efficiency is also be related to the type and composition of the effluent. In at least one embodiment, the abatement system is provided information about the type and composition of the effluent (e.g., in-situ and/or in real time and/or based on a reference system). The abatement system uses this information to tailor the use of the resources. Accordingly, the desired destruction efficiency may be achieved without overusing resources.

Furthermore, abatement initially may commence with the abatement system set to one or more maximum or high level settings that may be adjusted, e.g., lowered, to lower level settings based on analysis of effluent information. These lower level settings represent optimal abatement settings for the effluent gases of the recipe in use. These optimal abatement settings may be used while the corresponding recipe is in use, even without specific knowledge of the details of the recipe. When a new recipe is used, the abatement settings may be returned to precautiously high level settings while optimal abatement settings for the new recipe are determined. Use of high level settings may achieve maximum abatement strength as a precaution in the absence of effluent information that would indicate a need for less than maximum strength abatement.

### Exemplary Electronic Device Manufacturing System

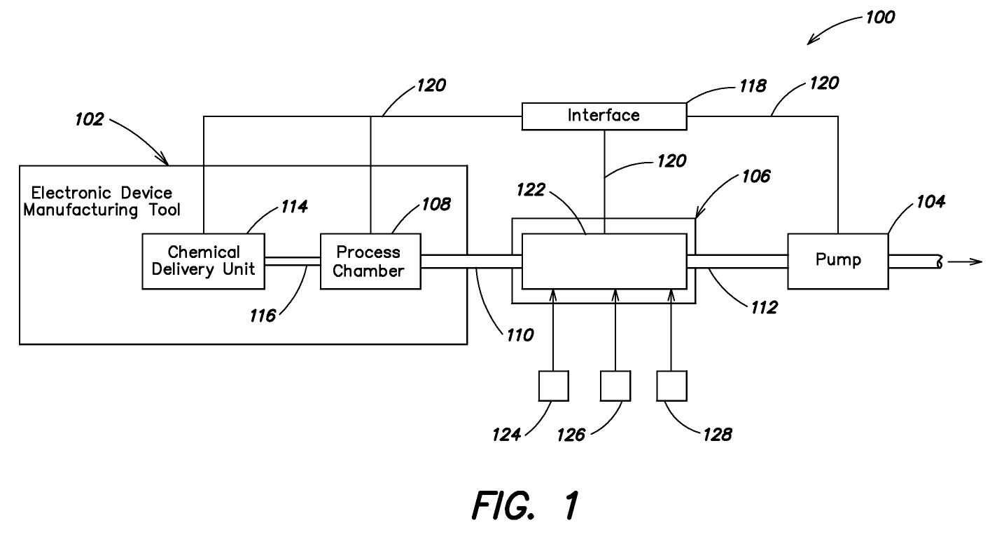

FIG. 1 is a schematic drawing depicting an electronic device manufacturing system having an electronic device manufacturing tool, a pump, an interface, and an abatement system in accordance with the present invention. The electronic device manufacturing system 100 may include an electronic device manufacturing tool 102, a pump 104, and an abatement system 106. The electronic device manufacturing tool 102 may have a process chamber 108. The process chamber 108 may be coupled to the abatement system 106 via a vacuum line 110. The pump 104 may be coupled to the abatement system 106 via a conduit 112. The process chamber 108 may also be coupled to a chemical delivery unit 114 via a fluid line 116. An interface 118 may be coupled to the process chamber 108, the chemical delivery unit 114, the pump 104, and the abatement system 106 via signal lines 120. The abatement system 106 may include a reactor 122 that may be coupled to a power/fuel supply 124, a reactant supply 126, and a cooling supply 128.

The electronic device manufacturing tool 102 may be adapted, by using processes, to manufacture (e.g., fabricate) electronic devices. The processes may be performed in the process chamber 108 at a pressure less than an ambient pressure (e.g., one atmosphere (atm), etc.). For example, some processes may be performed at pressures of about 8 to 700 milli-torr (mTorr), although other pressures may be used. To achieve such pressures the pump 104 may remove the effluent (e.g., gas, plasma, etc.) from the process chamber 108. The effluent may be carried by the vacuum line 110.

Chemical precursors (e.g., SiH₄, NF₃, CF₄, BCl₃, etc.), of the effluent being removed by the pump 104, may be added to the process chamber 108 by a variety of means. For example, the chemical precursors may be flowed to the process chamber 108 via the fluid line 116 from the chemical delivery unit 114. In addition, the chemical delivery unit 114 may be adapted to provide recipe information (e.g., pressure, chemical composition, flow rate, etc.), via the signal lines 120, related to the chemical precursors provided by the chemical delivery unit 114 via the signal lines 120.

The recipe information may be based on a known recipe, or the recipe information may be derived from an undisclosed recipe. Derivation of recipe information from an undisclosed recipe may involve determination of precursor composition or mass flow using various sensors, e.g., a mass flow controller, possibly integrated in the chemical delivery unit 114 or fluid line 116. A mass flow controller (MFC) is a device used to measure and control the flow of gases. A mass flow controller is designed and calibrated to control a specific type of gas at a particular range of flow rates. A gas composition sensor or device may accompany or be integrated with an MFC to provide gas composition information as part of the gas information measured in the system.

Mass flow controllers may have an inlet port, an outlet port, a mass flow sensor and a proportional control valve. The MFC can be given a setpoint from 0 to 100% of its full scale range but is typically operated in the 10 to 90% of full scale where the best accuracy is achieved. The device will then control the rate of flow to the given setpoint. The MFC may be fitted with a closed loop control system that may be given an input signal by the operator (or an external circuit/computer) that it compares to the value from the mass flow sensor and adjusts the proportional valve accordingly to achieve the required flow. The flow rate is specified as a percentage of its calibrated full scale flow and is supplied to the MFC as a voltage signal. Mass flow controllers conventionally require the supply gas to be within a specific pressure range. Low pressure will starve the MFC of gas and it may fail to achieve its setpoint, whereas high pressure may cause erratic flow rates.

The interface 118 may be adapted to receive further recipe information from the electronic device manufacturing system 100. For example, the interface 118 may receive recipe information related to processes in the process chamber 108. The information may include process information (e.g., substrate type, process type, process step time, temperature, pressure, plasma, fluid flows, etc.) and may be provided by a sensor, controller or other suitable apparatus. The interface 118 may use such information to determine additional information, for example, parameters of the effluent.

Effluent information determined from the recipe information may be predictive of the actual effluents exiting the electronic device manufacturing tool 102. In addition, or alternatively, actual effluents exiting the process chamber 108 may be measured directly upon exiting the chamber 108, while traversing the vacuum line 110, and/or upon entering the abatement system 106. Direct measurement of the effluents may involve, for example, the use of a gas composition sensor and an MFC. This effluent information may be used as a basis for adjusting the abatement settings for optimal abatement of the materials needing abatement.

In one or more embodiments, the interface 118 may also receive information from one or more databases containing information concerning known behaviors of the process-related parameters. As described in previously-incorporated U.S. patent application Ser. No. 11/685,993 (Attorney Docket No. 9137), the database may be populated with information derived from an instrumented reference system, such as a second an electronic device manufacturing system 100, or having a similar design to the electronic device manufacturing system 100, in which system parameters may be precisely measured over time.

The parameter measurements taken by the reference system may be used to derive functions (e.g., best-fit curves, normal distribution equations, etc.) describing the behavior of one or more of the parameters over time, or as a function of one or more other parameters. These functions can be described using constants that can then be organized in a database accessible by the interface 118. The interface 118 may use the information in the database to determine desired and/or optimal values at which to adjust actual parameters of the electronic manufacturing system 100.

The interface 118 may provide the information related to the effluent to the abatement system 106. Such effluent information may be employed to adjust parameters of the abatement system 106. The effluent may be carried by the vacuum line 110 from the process chamber 108 to the abatement system 106. The pump 104 may remove the effluent from the process chamber 108 and move the effluent to the abatement system 106. The abatement system 106 may be adapted to attenuate the undesirable material in the effluent using the power/fuel supply 124, reactant supply 126, and/or cooling supply 128.

In an exemplary embodiment, the abatement system 106 may be a plasma abatement system. An exemplary plasma abatement system may be the LITMAS™ system available from Metron Technology, Inc., of San Jose, Calif., although other abatement systems may be used. The abatement system 106 may use fuel/power supplied by the fuel/power supply 124, reactants (e.g., water, water vapor, O₂, H₂, etc.) supplied by the reactant supply 126, and cooling water or another suitable fluid supplied by the cooling supply 128. The abatement system 106 may form plasma that may be employed to attenuate or eliminate undesirable material in the effluent, as will be described in more detail below.

In the same or alternative embodiment, a post-pump abatement system may be included. For example, the abatement system 106 may not be present in the electronic device manufacturing system 100. Instead, the post-pump abatement system may be included downstream from the pump 104. Alternatively, a post-pump abatement system may be employed in addition to the abatement system 106. The information related to the effluent may also be provided to the post-pump abatement system.

### Exemplary Method Embodiments

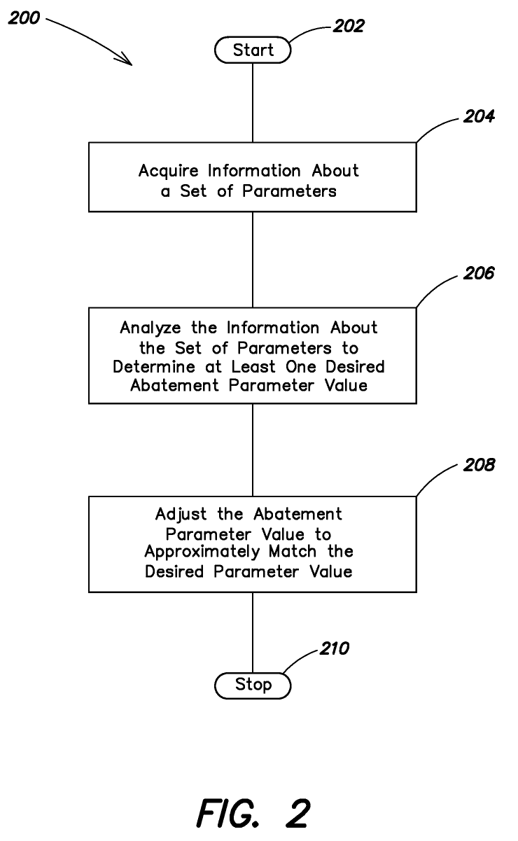

FIG. 2 is a flowchart depicting a method of adjusting an abatement system 106 in accordance with the present invention. The method 200 begins with a start step 202, which may include processing a substrate of a recipe lot. The start step 202 may commence abatement of effluent gases from the recipe lot upon commencing processing of the substrate.

In start step 202, abatement of the effluents may commence at high level settings of the abatement system 106. The high level settings may approach a maximum strength of the abatement system 106. Maximum strength settings may be used as a precaution against possible lack of abatement of materials needing abatement in the effluent, in the absence of effluent information. Use of maximum strength abatement may be a temporarily inefficient use of resources that may be remedied by adjustment of the abatement level settings upon determination and implementation of optimal abatement settings for the recipe lot.

Subsequently, an information acquisition step 204 may be performed, in which the interface 118 or another suitable apparatus may acquire information about a set of parameters. The parameters relate to the processing of the recipe lot and may include, for instance, recipe information and/or effluent information, and may be either measured, determined, or a combination thereof. Measurement and determination may be direct or indirect.

In information acquisition step 204, the interface 118 may acquire the information from one or more information sources, such as the electronic device manufacturing system 100, an internal or external database, a predictive solution, a reference system, etc. The information may relate to, or be used to derive information relating to, one or more effluents produced by the electronic device manufacturing system 100. The information may also include system information, such as system configuration information and/or equipment information, such as the type, capabilities, and operating ranges of the abatement system 106 that may be employed by the electronic device manufacturing system 100. In addition, the system information may include settings information regarding the settings in use by the equipment of the system at a given time. Subsequently, an information analysis step 206 may begin.

In information analysis step 206, the interface 118 and/or abatement system 106 may analyze the information acquired in step 204 to determine at least one desired abatement parameter value. If necessary, the desired abatement parameter value may be converted into an optimal abatement setting of the abatement system 106. Moreover, the interface may analyze the information to determine that, for recipe and the type of abatement system 106, a parameter of the abatement system 106 may need to be adjusted to optimize abatement of the effluent. For example, for a pre-pump plasma abatement system 106 attenuating gaseous chemicals (e.g., perfluorocarbons (PFCs), selected organic compounds (VOCs), etc.) a plasma power may be adjusted. The amount that the gaseous chemicals are attenuated may be proportional to the amount of plasma power is applied to the gaseous chemicals. For example, PFCs may require tens of electrons per molecule to cause any substantial dissociation and thereby attenuate the PFCs to the desired level.

In an abatement adjustment step 208, abatement settings may be adjusted to optimal abatement settings to approach optimized abatement parameters. For instance, by adjusting the plasma power to an optimal level, the abatement process may be optimized. Aspects of the present invention may involve reduction of abatement parameters by lowering abatement settings from high level settings initially set to obtain maximum abatement strength. Lowering abatement settings away from maximum strength levels reduces resource consumption as well as equipment wear. For example, a higher-than-optimal amount of plasma power is excessive and may undesirably damage the reactor 122 walls. More specifically, damage to the reactor 122 walls may be proportional to the amount of electrons per molecule that are present in the plasma. Thus, by providing an optimal amount of plasma power, the reactor 122 may be damaged through wear less quickly and hence need to be replaced less often.

In other embodiments, adjustments may be made during abatement adjustment step 208 to other types of abatement systems 106. For example, a post-pump plasma, catalytic, and/or combustion abatement system 106 may be employed. In the post-pump plasma abatement system 106, the parameters that may be optimally adjusted may include power, purge gas flow, reactant, and coolant flow. For a post-pump catalytic abatement system 106, the parameters that may be adjusted may include purge gas flow, reactant, and coolant flow. For a post-pump combustion catalytic abatement system 106 the parameters that may be optimally adjusted may include fuel flow, purge gas flow, reactant and coolant flow.

Moreover, abatement adjustment step 208 may involve adjustments to the recipe and/or other pre-abatement processes to preemptively abate materials needing abatement in the effluents before the creation of the effluents. For instance, acquisition and analysis of effluent information may indicate that excessive precursor materials are being used, which unnecessarily generates additional materials needing to be abated.

Analysis of the information in step 206 and abatement adjustment in step 208 may be performed automatically by appropriate equipment, computer hardware, and/or computer software, in accordance with aspects of the present invention. For instance, the interface 118 may contain software that interacts with computer hardware to automatically monitor and control equipment in the manufacturing system 100, such as the abatement system 106. Likewise, the interface 118 may include logic programming, in the form of software or firmware, that determines the optimal setting based on a selected setting efficiency and gas information. The selected setting efficiency may include user input data indicative of the perceived importance of abating an undesirable material relative to resource consumption for incremental units of efficiency, as discussed more below.

In such an automated embodiment of the present invention, the abatement system 106 automatically may adjust the abatement settings and parameters to match the optimal abatement settings and desired parameter values. For example, the plasma power may be increased to a desired amount due to an increase in the amount of PFCs in the effluent. Alternatively, if starting with the abatement settings at or near maximum strength, the abatement settings may be reduced to optimal abatement settings in view of the effluent information, so as to optimize abatement while conserving resources.

In an end step 210, the method 200 subsequently may end, which may include completion of the recipe lot processing and commencement of a new recipe lot. Commencement of a new recipe lot may result in restarting method 200 at start step 202.

As introduced above in regard to automated embodiments of the present invention, aspects of the present invention may include performing one or more actions of method embodiments by using computer software executed on computer hardware. Parameters and logic corresponding to these actions may be embodied in computer programming code for compilation and execution by computer processors. The computer processors executing the code may adjust the performance of the actions based in part, for instance, on system data, process feedback, or user input, as is customary with the automation of manufacturing processes and/or equipment. For example, temperature sensors may provide temperature data which may trigger computer instructions to adjust effluent flow rates.

In conjunction with the automation of one or more aspects of a system in accordance with an embodiment of the present invention, computer software for process and/or equipment automation may be embodied in computer readable media or in inter-computer communication, either in compiled or uncompiled formats. Inter-computer communication may include, for instance, remote access and/or control of on-site equipment by off-site software or hardware under third-party control. Appropriate computer software and/or hardware may be integrated or embedded in the system or system components, or provided separately.

### First Exemplary Abatement Setting Relationship

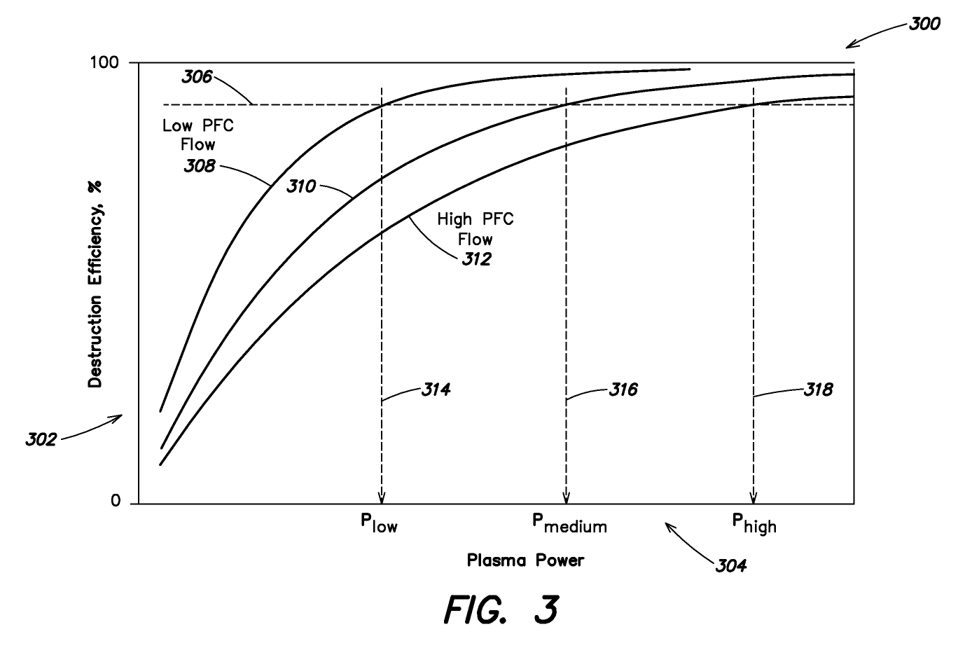

FIG. 3 is a figure depicting a curve showing a first relationship between a destruction efficiency and a plasma power used by the plasma abatement system employing the exemplary abatement process in accordance with the present invention. A first relationship 300 may be between destruction efficiency 302 and a plasma power 304 of the abatement process. In this first relationship 300, adjustment of the plasma power 304 setting may be optimized to approach optimal destruction efficiency 302.

In FIG. 3, the undesirable material being attenuated is depicted as being PFCs. A desired destruction efficiency 306 may be depicted by a horizontal dashed line. A low PFC flow curve 308, a medium PFC flow curve 310, and a high PFC flow curve 312 may be indicative of the first relationship 300 between the destruction efficiency 302 and the plasma power 304 for a PFC flow rate through the abatement system 106. A maximum plasma power setting would be at the far right of the x-axis. Accordingly, a low power line 314, a medium power line 316, and a high power line 318 are staggered progressively to the right along the x-axis. Power lines 314, 316, and 318 may indicate the amount of plasma power 304 applied to the PFCs.

The destruction efficiency 302 of the PFCs may be related to the flow rate of the PFCs. For example, the higher the flow rate through the abatement system 106, the lower the destruction efficiency 302 of the PFC may be at the given plasma power 304. Thus, the plasma power 304 may be adjusted to achieve the desired destruction efficiency 306. The desired destruction efficiency 306 may range from about 85 percent to about 100 percent. For a high PFC flow rate, the high PFC flow curve 312 may be employed to determine the amount of plasma power 304 that may be required to achieve the desired destruction efficiency 306 for a high PFC flow rate. The high power line 318 indicates the amount of plasma power 304 required to achieve the desire destruction efficiency 306. In this manner the appropriate level of plasma power 304 may be selected.

In embodiments of the invention starting at a high or maximum level plasma power setting, destruction efficiency may approach 100%. However, as the curves 308, 310, 312 level off towards the right, a marginal increase in plasma power 304 tends to have a decreasingly increasing effect on the destruction efficiency 302. As such, the first relationship 300 may be characterized by a setting efficiency, where the setting efficiency may correspond to a differential relationship of the abatement setting versus destruction efficiency, expressing a relative increase or decrease in marginal destruction efficiency per unit increase in the abatement setting from a reference abatement setting. For instance, a setting efficiency for curve 308 appears to be greater than one before power line 314 (e.g., curve 308 is steep), but drops below one beyond power line 314 (e.g., curve 308 becomes flat).

Depending on materials to be abated, a decision may be made of avoid this diminishing return on the use of resources by choosing to abate the materials to a selected setting efficiency. In FIG. 3, the selected setting efficiency corresponds to the desired destruction efficiency 306, which represents an intentional compromise between conservation of resources (e.g., plasma power 304) and destruction efficiency 302. Hence, an optimal abatement setting may be considered to include, for instance, plasma power line 318 for a high PFC flow 312.

In alternative embodiments, the number of plasma power 304 levels available to be selected may be more or less than three, as depicted in FIG. 3. For example, more than three plasma power 304 levels may be available for selection. More specifically, a continuous range of plasma power 304 may be available for selection. Alternatively, a single power level may be available for an on/off application of plasma power 304 for a flow of low levels of PFC. Likewise, more than three flow rate curves may be available for selection of the appropriate levels of power to achieve the desired destruction efficiency 306. For example, a relationship between the plasma power 304 and the destruction efficiency 302 may be defined over a continuous range of PFC flow rates. Such a relationship and corresponding relationship curve may represent a predictive tool to predict actual consequences of setting adjustments on destruction efficiency to arrive at a predictive solution for attenuation of the undesirable material relative to the setting subject to adjustment.

### Second Exemplary Abatement Setting Relationship

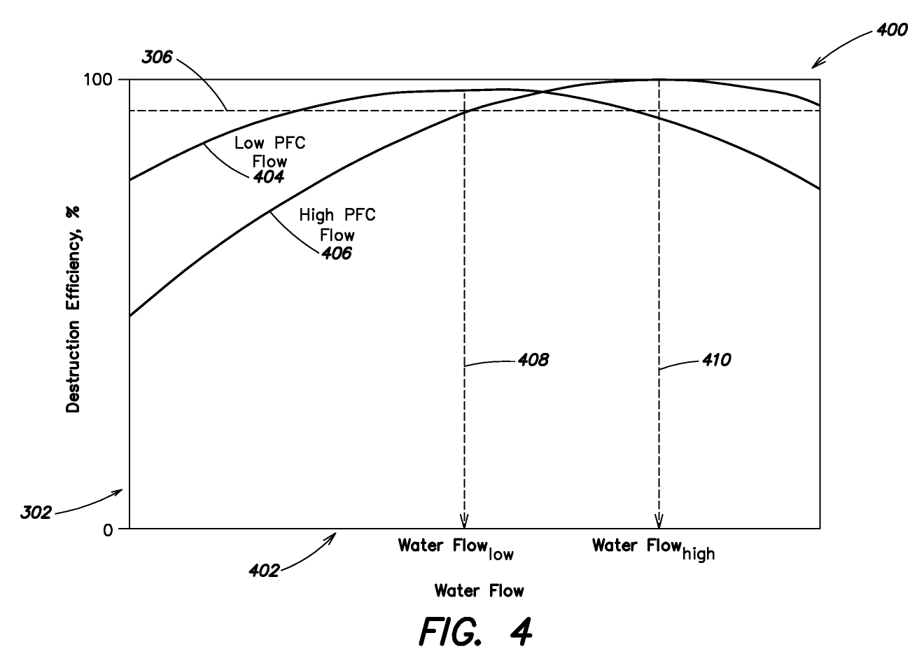

FIG. 4 is a figure depicting a curve showing a second relationship between destruction efficiency and a reactant flow, using water as a reactant, in a plasma abatement system employing the exemplary abatement process in accordance with the present invention. A second relationship 400 between the destruction efficiency 302 and the water flow 402 is depicted by a low PFC flow curve 404 and a high PFC flow curve 406, where PFC is the material to be abated, as in FIG. 3. In this second relationship 400, adjustment of the water flow 402 setting may be optimized to approach optimal destruction efficiency 302. A maximum water flow setting would be at the far right of the x-axis. Accordingly, a water flow low line 408 depicts the peak of the low PFC flow curve 404. Farther to the right, a water flow high line 410 depicts the peak of the high PFC flow curve 406.

The desired destruction efficiency 306 may be achieved or exceeded by adjusting the water 402 to appropriate peak water flow. Although two PFC flow curves are depicted, embodiments of the present invention may employ only one curve or more than two curves. Alternatively, a continuous spectrum of PFC flows may be employed by the present invention. The present invention may employ such a relationship to determine the appropriate water flow to optimally attenuate the PFC in the effluent.

In embodiments of the invention starting at a high or maximum level water flow setting, destruction efficiency may deviate from 100%. Hence, the curves 404, 406, not only level off towards the right, but also peak and begin to drop. Thus, depending on the flow of material to be abated, marginal increases in water flow 402 first may exhibit a decreasingly increasing effect and then may exhibit a decreasing effect on the destruction efficiency 302.

As with the first relationship 300, the second relationship 400 may be characterized by a setting efficiency, where the setting efficiency may correspond to a differential relationship of the abatement setting versus destruction efficiency. In FIG. 4, curves 404 and 406 demonstrate both a relative increase and decrease in marginal destruction efficiency per unit increase in the abatement setting from a reference abatement setting. For instance, a setting efficiency for curve 404 appears to be greater than zero before flow line 408 (e.g., curve 408 rises), but drops below zero beyond flow line 408 (e.g., curve 308 falls).

Depending on materials to be abated, a decision may be made of avoid this diminishing return on the use of resources by choosing to cap the maximum reactant setting at the setting corresponding to the peak of the destruction efficiency curve of a highest predictable flow of the materials to be abated. In addition, an optional setting efficiency may be selected for the abatement setting.

In FIG. 4, the selected setting efficiencies may correspond to flow lines 408, 410, which exceed the desired destruction efficiency 306 of FIG. 3. Hence, an optimal abatement setting may be considered to include, for instance, water flow line 410 for a high PFC flow curve 406. Alternatively, the selected setting efficiencies may be below the corresponding highest destruction efficiency for the effluent flow, such that the selected setting efficiencies correspond to the desired destruction efficiency 306, which represents an intentional compromise between conservation of resources (e.g., reactant flow 402) and destruction efficiency 302.

Additionally, the relationship 400 may be related to chemical reaction of the abatement process. For example, abatement of carbon tetrafluoride (CF₄) may include oxidizing the carbon and hydrogenating the fluorine. Hydrogen and oxygen may be supplied as hydrogen oxide (water) according to the reaction: CF₄+2 H₂O→CO₂+4 HF, where one part of CF₄ may require two parts of water for complete transformation. Thus, the water flow may be twice the CF₄ flow. In some embodiments, a water flow of up to about seven times the CF₄ or other PFC gas flow may be employed.

The foregoing description discloses only exemplary embodiments of the invention. Modifications of the above disclosed apparatus and method which fall within the scope of the invention will be readily apparent to those of ordinary skill in the art. For instance, the interface may be included in the electronic device manufacturing tool wherein the abatement system is communicatively coupled with the electronic device manufacturing tool to acquire the information related to the effluent.

Accordingly, while the present invention has been disclosed in connection with exemplary embodiments thereof, it should be understood that other embodiments may fall within the spirit and scope of the invention, as defined by the following claims.

1. A method comprising:
starting an abatement system at a high level setting;
receiving an effluent having an undesirable material at the abatement system;
abating the undesirable material using the abatement system at the high level setting;
receiving information about the effluent;
analyzing the information to determine an optimal setting, wherein the optimal setting corresponds to a selected setting efficiency;
adjusting the high level setting to the optimal setting; and
receiving more of the effluent having more of the undesirable material.

2. The method of claim 1 wherein the information regards a predictive solution related to the undesirable material.

3. The method of claim 1 wherein the information is provided by an interface.

4. The method of claim 3 further comprising providing to the interface system information related an electronic device manufacturing system comprising the abatement system.

5. The method of claim 1 further comprising attenuating more of the undesirable material with the abatement system.

6. The method of claim 5 wherein attenuating more of the undesirable material with the abatement system includes reacting the undesirable material with reactants.

7. The method of claim 1 wherein the abatement system is a plasma abatement system.

8. The method of claim 1 wherein the abatement system is a catalytic abatement system.

9. The method of claim 1 wherein the abatement system is a combustion abatement system.

10. The method of claim 1 wherein the effluent is produced by a process chamber.

11. A system comprising:
at least one sensor adapted to measure gas information about gas present in an electronic device manufacturing system, and to communicate the gas information;
an interface adapted to receive and analyze the gas information from the electronic device manufacturing system that produces an effluent having an undesirable material, to determine an optimal setting, and to communicate the optimal setting, wherein the optimal setting corresponds to a selected setting efficiency; and
an abatement system adapted to receive the optimal setting, to receive the effluent, and to attenuate the undesirable material;
wherein the abatement system is further adapted to commence abatement of the undesirable material of the effluent of a recipe lot while operating at a high level setting; and
wherein the abatement system is further adapted to adjust the high level setting to the optimal setting upon receiving the optimal setting.

12. The system of claim 11 wherein the interface comprises logic programming that determines the optimal setting based on the selected setting efficiency and the gas information.

13. The system of claim 11 wherein the interface is further adapted to receive and analyze information regarding a predictive solution related to the undesirable material.

14. The system of claim 13 further comprising providing to the interface system information related the electronic device manufacturing system comprising the abatement system, wherein system information may comprise configuration information, equipment information, settings information, or any combination thereof.

15. The system of claim 11 wherein the gas information may comprise recipe information, effluent information, or both.

16. The system of claim 11 wherein the high level setting and the optimal setting of the abatement system relate to reacting the undesirable material with reactants.

17. The system of claim 11 wherein the abatement system is a plasma abatement system.

18. The system of claim 11 wherein the abatement system is a catalytic abatement system.

19. The system of claim 11 wherein the abatement system is a combustion abatement system.

20. The system of claim 11 wherein the effluent is produced by a process chamber.
